(19) United States
(12) Patent Application Publication
(10) Pub. No.: US 2004/0155523 A1
(43) Pub. Date: Aug. 12, 2004

(54) Method and brake system for modifying and adjusting the braking force in a vehicle

(76) Inventors: Georg Frentz, Nuertingen (DE); Taner Kandemir, Stuttgart (DE); Ralf Koerber, Stuttgart (DE); Matthias Leber, Stuttgart (DE); Arthur Pradt, Herrenberg (DE); Hans-Georg Reidl, Pforzheim (DE); Roland Schwarz, Moessingen (DE); Ulrich Stoll, Boeblingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/398,771

(22) PCT Filed: Oct. 9, 2001
(86) PCT No.: PCT/EP01/11655

(30) Foreign Application Priority Data
Oct. 12, 2000 (DE) 100 50 466.3

(51) Int. Cl. B60T 8/60

(52) U.S. Cl. 303/155

(57) ABSTRACT

The invention relates to a method for modifying and adjusting the braking force in a hydraulic brake system in a vehicle, whereby the pedal control exercised by the driver is measured and is converted via a predefined function into braking pressure to be produced in a wheel brake device, said pressure corresponding to a deceleration of the vehicle. In order to increase the braking safety, the braking pressure or the variable correlating with the braking pressure can be individually manipulated as a function of the pedal control within a section of said pedal control between the initial starting point and maximum pedal control point.

The invention relates to a method and a brake system for variably setting the braking force in a motor vehicle according to the preamble of claim 1 or 10.

The publication DE: 33 26 556 A1 discloses a hydraulic brake system for motor vehicles in which the pedal activation in determined by sensor means and is converted into a corresponding brake pressure using a predefined relationship. For this purpose, the brake pedal is provided with a measuring device with which either the pedal travel or the pedal force in measured. The generated measurement signal is fed to a control device in which a desired deceleration of the vehicle or a desired brake pressure, which is generated by appropriate actuation of the wheel brake device, in derived from the magnitude of the measurement signal in accordance with a stored characteristic curve.

In such brake systems which are also known under the term electrohydraulic brakes, it is possible for deviations from a predefined setpoint curve to occur in the braking behavior owing to production-related component tolerances. Such deviations must be compensated in the pressure profile by means of subsequent standardizations and adaptations.

Further problem& may arise as a result of the fact that the braking behavior is influenced by heat, wetness, wear of components or other conditions, which may result in hazardous situations.

Finally, the braking behavior is also influenced by the braking behavior which varies on an individual basis from driver to driver an various drivers in comparable situations activate the brake pedal to differing degrees.

The invention in based on the problem of increasing the driving safety in vehicles by means of an improved braking.

This problem is solved according to the invention with a method having the features of claim 1, and with a brake system having the features of claim 10.

According to the method, the brake pressure or the variable which correlates to the brake pressure—in particular the deceleration of a vehicle which can be calculated directly from the brake pressure from a known, predefined relationship—is varied on a vehicle-specific basis and/or driver-specific basis within acceptable limits as a function of the pedal activation. This makes it possible for variations, which are due, for example, to component tolerances of the brake system, to be compensated automatically and/or by means of interventions from the outside, for example at service intervals, and to be approximated, for example, to a predefined setpoint curve which is representative of a specific type of brake system. This makes it possible to ensure, in particular, that a specific type of brake system generates the same brake pressure or the same braking deceleration in different vehicles when the brake in activated in the same way, despite unavoidable component tolerances.

A further advantage is the fact that it is possible to adapt the brake pressure during the ongoing operation of the vehicle, in particular even while a braking operation is taking place, as a result of which in particular fading of the brake can be compensated. However, if appropriate additional conditions, for example the temperature of the brake disks or of other brake components which are directly necessary for the braking operation are also taken into account here in order to avoid overheating.

The individual adaptation finally makes it possible to change the brake pressure characteristic curve on a driver-specific basis so that driver-specific requests can also be allowed for in that the braking request is sensed to a greater or lesser degree.

In order to avoid a situation in which unacceptably large differences occur between two comparable brake systems as a result of a vehicle-specific and/or driver-specific change in the brake pressure characteristic curve, it is possible to adapt the brake pressure characteristic cure only within acceptable limits which can be predefined. Predefining these limits, which can be done either as a band to be defined below and above a setpoint brake pressure profile as a function of the pedal activation or by means of a starting point and/or end point to be predefined in the brake pressure profile, ensures that faults in the brake system which should no longer be tolerated can be detected. By monitoring the brake pressure it is possible to detect a fault or disruption if the brake pressure is outside the acceptable limits. Such an instance of disruption is expediently displayed to the driver; at the same time, the brake pressure can be approximated at least to the closest braking value so that at least the maximum braking force still possible can be utilized.

Either the pedal travel or the pedal force can be measured an the pedal activation and can be used as the basis for determination of the brake pressure. In a regulated embodiment, the actual brake pressure is measured and approximated to the computationally determined setpoint brake pressure which is determined as a function of depending on the pedal activation. However, in a controlled embodiment it may be sufficient to set the brake pressure in accordance with a predefined relationship without measuring the actual brake pressure.

The brake pressure is not manipulated over the entire value range of the pedal activation but rather only between a first pedal position and a second pedal position, a part of the entire range of the pedal activation which is made available to the driver being defined by means of the two pedal positions. This part of the range or section expediently begins at the home position of the pedal and ends in a central pedal activation region which lies between the home position and the maximum possible activation position. The brake pressure is advantageously manipulated only in this initial section, but not in the section up to the maximum pedal activation at which the maximum brake pressure or the maximum braking deceleration becomes effective. This is intended to ensure that the driver cannot attenuate the braking force in the braking range up to the maximum braking deceleration which is particularly relevant to safety and which is generally only utilized in emergency situations.

However, in one alternative embodiment it may also be expedient to extend the range which can be manipulated to the entire pedal activation range. Finally, it may also be advantageous to predefine variable limits as a function of the current pedal activation and/or a% a function of other vehicle state variables and vehicle operating variables within which a manipulation is permitted. It may thus be expedient, for example, to define, in a low metering range starting from the home position of the pedal, relatively wide limit within which a manipulation is permitted, and to increasingly narrow down the limits as the pedal activation progresses in the direction of the maximum pedal position. In particular, in the region of the maximum deflection of the pedal it may be advantageous to permit only boosting of the brake pressure but no attenuation.

Further advantages and expedient embodiments can be found in the further claims, the description of the figures and the drawings, in which:

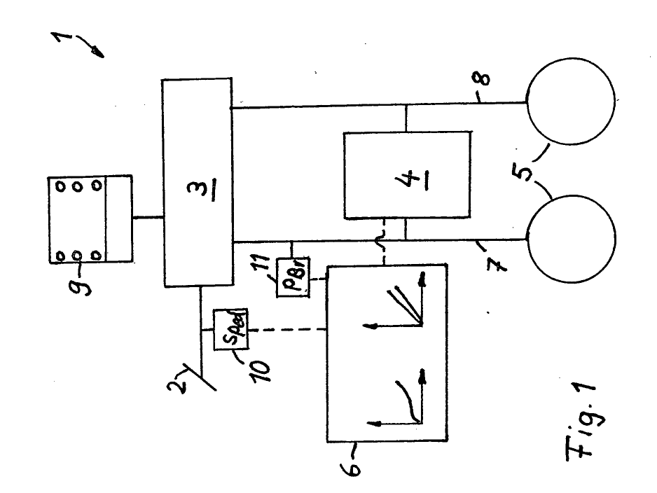

FIG. 1 shows a schematic view of an electrohydraulic brake system for a motor vehicle which has a control device for manipulating the brake pressure,

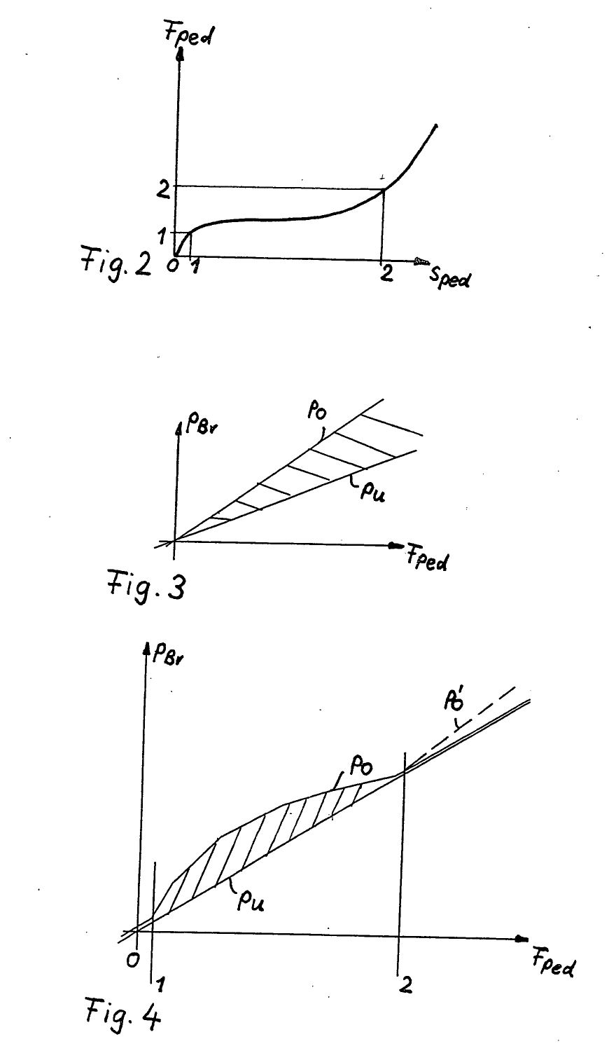

FIG. 2 shown a diagram of the profile of the pedal force as a function of the pedal activation of the brake pedal,

FIG. 3 shows a diagram of a permissible adjustment range for the brake pressure as a function of the pedal force,

FIG. 4 shows a diagram with a modified profile of a brake pressure as a function of the pedal force.

The brake system 1 shown in FIG. 1 is embodied as an electrohydraulic brake and comprises a brake pedal 2 which is connected to a brake pressure generator 3 which is connected to a wheel brake device 5 via hydraulic lines 7 and 8. Furthermore, a hydraulic unit 4 which is connected to the hydraulic lines 7 and 8 and has the purpose of generating a desired brake pressure p_{Br} is provided. The pedal travel of the brake pedal 2 is measured by means of a travel sensor 10 and the hydraulic pressure p_{Br} in the hydraulic lines 7 and a is determined by means of a pressure sensor 11. Furthermore, a control device 6 in provided which receives measurement signals of the sensors 10 and 11 and generates control signals as a function of the measurement signals, said control signals being fed to the hydraulic unit 4 in order to set the desired brake pressure p_{Br}.

A pedal travel simulator 9, by means of which an elastically resilient pedal behavior of the brake pedal 2 can be generated, is assigned to the brake pressure generator 3.

When the brake pedal 2 is activated by the driver, the brake pressure generator 3 which is in particular embodied am a hydraulic tandem cylinder is acted on by the brake pedal 2, a direct transmission of pressure to the wheel brake device 5 being possible in cases of destruction—when there is a defective brake system via the hydraulic lines 7 and a between the brake pressure generator 3 and the wheel brake device 5.

When the brake system 1 is functionally capable, the pedal travel s_{ped} of the brake pedal 2 is measured by means of the travel sensor 10 and transmitted as a measurement signal to the control device 6. A brake pressure p_{Br,sctp}, which is assigned to the current value of the pedal travel or a variable which correlates to the brake pressure, in particular the deceleration of the vehicle, is determined in the control device 6 as a function of the measured pedal travel s_{ped}. The brake pressure or the variable which correlates to the brake pressure is transmitted as a setpoint variable to the hydraulic unit 4 in which the pressure $i correspondingly set and transmitted to the wheel brake device 5 via the hydraulic lines 7 and 8.

The actual brake pressure p_{Br} can be set in either a regulated or unregulated way. In the regulated case, the actual brake pressure par in the hydraulic lines 7 and a is measured by means of the pressure sensor 11 and transmitted as a measurement signal to the control device 6 in which the control signals which act on the hydraulic unit 4 are generated in such a way that the measured brake pressure p_{Br} is approximated to the setpoint pressure profile p_{Br,sctp}. In contrast, in the unregulated case, it in possible to dispense with measurement of the actual brake pressure p_{Br} by means of the pressure sensor 11; exclusively controlled setting of the actual brake pressure to the determined setpoint profile takes place.

It may, if appropriate, be expedient to measure, instead of the pedal travel s_{ped}, the pedal force exerted by the driver on the brake pedal 2 and to determine the desired brake pressure p_{Br} an a function of the measured pedal force.

In the case of a measured pedal travel s_{ped} it is possible to determine an assigned pedal force F_{ped} from the pedal travel s_{ped} in accordance with the relationship shown in FIG. 2. The brake pedal is expediently embodied in such a way that the pedal force F_{ped} assumes a highly nonlinear profile over the pedal travel s_{ped}, a strong rise being observed in a first section between the unactivated home position of the pedal (position 0) up to a first position 1, which closely follows the home position, only a slight rise taking place between the first position 1 and a second position 2, and again a relatively strong rise occurring again starting from the position 2 up to the maximum position of the brake pedal.

The brake system is constructed in such a way that the brake pressure p_{Br} which acts on the wheel brake device can be varied within predefined limits for a given pedal position. This variation can either be carried out automatically by means of the control device so that, for example, brake devices which differ too much in their braking behavior from a given mean value can be standardized to this mean value, or in order to permit ;driver-specific settings, the driver being given the possibility of sensing the brake request to a greater or leaser degree in order to set a relatively hard or relatively soft braking behavior.

Such a manipulation range for the brake pressure par is illustrated in FIGS. 3 and 4 as a function of the pedal force F_{ped}. In FIG. 3, an upper limit pₒ and a lower limit pᵤ are predefined, marking a permissible manipulation range for the brake pressure p_{Br} within which automatic or manually set changes of the brake pressure are permissible. The upper limit pₒ and the lower limit pᵤ are advantageously each embodied as lines passing through the origin and define a brake pressure range which fans out am the pedal force F_{ped} increases.

A nonlinear profile of a brake pressure upper limit pₒ is plotted in FIG. 4. The permissible manipulation range within which variations of the brake pressure p_{Br} are permitted lies between the pedal positions 1 and 2 which can be predefined as a function of travel according to FIG. 2 and have been transmitted into corresponding force positions in FIG. 4. The upper limit pₒ of the brake pressure assumes a nonlinear profile in this permitted manipulation range. The upper limit pₒ firstly increases progressively starting from the position 1 and then drops digressively toward the position 2. In the exemplary embodiment, the lower limit pᵤ is a straight line passing through the origin. Between the home position of the pedal 0 and the first position 1 as well as above the, second position 2, the upper limit pₒ and lower limit pᵤ coincide so that in these regions it is not possible to vary the brake pressure p_{Br}.

According to an alternative embodiment, it is, however, also possible to show that a permissible manipulation range for the brake pressure can also be defined in the aforesaid regions before the position 1 and after the position 2. It may, for example, be expedient to define a permissible brake pressure band with parallel upper limit and lower limit above the position 2, or else, as represented in FIG. 4 with a dashed line for the upper limit pₒ, to define a manipulation range which opens out.

A driver-specific manipulation of the brake pressure profile as a function of the pedal travel or the pedal force can expediently be stored in the control device and activated individually for each driver. The activation can be tied to specific settings in the vehicle, for example to settings at the seat.

1. A method for variably Setting the braking force in a hydraulic brake system of a motor vehicle, the pedal activation which is carried out by the driver being measured and being converted, by means of a predefined relationship, into a brake pressure (p_{Br}) which corresponds to a specific deceleration of the vehicle and is to be generated in a wheel brake device (5) or into a variable which correlates to the brake pressure, the brake pressure (p_{Br}) or the variable which correlates to the brake pressure being manipulated on an individual basis as a function of the pedal activation within a section of the pedal activation between the home position of the pedal and the maximum pedal activation position, characterized in that the manipulation of the function is possible only within variable limits which depend on the pedal activation and/or on other vehicle state variables.

2. The method as claimed in claim 1, characterized in that the pedal travel (s_{ped}) is used as the pedal activation.

3. The method according to claim 1 or 2, characterized in that the pedal force is used as the pedal activation.

4. The method as claimed in one of claims 1 to 3, characterized in that the brake pressure (p_{Br}) or the variable which correlates to the brake pressure is manipulated in a section starting at the home position of the pedal.

5. The method as claimed in one of claims 1 to 4, characterized in that the profile of the brake pressure (p_{Br}) or of the variable which correlates to the brake pressure is approximated to a permanently predefined setpoint curve as a function of the pedal activation.

6. The method as claimed in one of claims 1 to S, characterized in that the profile of the brake pressure (p_{Br}) or of the variable which correlates to the brake pressure is set automatically.

7. The method as claimed in one of claims 1 to 6, characterized In that the profile of the brake pressure (p_{Br}) or of the variable which correlates to the brake pressure can be influenced on a driver-specific basis.

8. The method as claimed in claim 7, characterized in that the profile of the brake pressure (p_{Br}) or of the variable which correlates to the brake pressure can be stored and activated for a specific driver.

9. The method as claimed in one of claims 1 to 8, characterized in that the profile of the brake pressure (p_{Br}) or of the variable which correlates to the brake pressure is changed in proportion to a mean value of the brake pressure (p_{Br}) or of the variable which correlates to the brake pressure.

10. A hydraulic brake system in a motor vehicle for variably setting the braking force, in particular brake system (1) for carrying out the method as claimed in one of claim 1 to 9, having a measuring device for measuring the pedal activation which is carried out by the driver, and having a control device (6) for generating a control signal for applying brake pressure (p_{Br}) to 4a wheel brake device (5), the control signal being generated in accordance with a predefined relationship as a function of a measurement signal which is generated in the measuring device, the relationship between the pedal activation and the brake pressure (p_{Br}) or a variable which correlates to the brake pressure being able to be varied by manipulating the control signal on an individual basis as a function of the pedal activation within a section of the pedal activation between the home position of the pedal and the maximum pedal activation position, characterized in that the manipulation of the function is possible only within variable limits which depend on the pedal activation and/or on other vehicle state variables.
